(19) United States
(12) Patent Application Publication
(10) Pub. No.: US 2026/0202629 A1
(43) Pub. Date: Jul. 16, 2026

(54) OPTICAL ALIGNMENT APPARATUS

(71) Applicant: AIP Inc., New Taipei City (TW)

(72) Inventor: Chia LEE, New Taipei City (TW)

(21) Appl. No.: 19/564,333

(22) Filed: Mar. 12, 2026

Related U.S. Application Data
(63) Continuation-in-part of application No. 19/089,040, filed on Mar. 25, 2025.
(60) Provisional application No. 63/657,872, filed on Jun. 9, 2024.
(60) Provisional application No. 63/885,353, filed on Sep. 21, 2025.

(51) Int. Cl. G02B 6/42

(52) U.S. Cl. CPC G02B 6/4221; G02B 6/4214

(57) ABSTRACT

An optical alignment apparatus includes an optical processing device, at least an alignment optical fiber unit, a computer control system, and a multiaxial adjustment device. The optical processing device is configured to generate a detection result. The computer control system is configured to generate an adjustment signal based on the detection result. A first coupling end of a first alignment optical fiber is positioned at a first distance from a first reflection portion in a first direction, and a second coupling end of a second alignment optical fiber is positioned at a second distance from a second reflection portion in the first direction. The multiaxial adjustment device is configured to, based on the adjustment signal, adjust a position of the ferrule element such that the first distance and the second distance are equal.

### CROSS REFERENCE TO RELATED APPLICATIONS

This application claims the benefit of U.S. provisional patent application Ser. No. 63/885,353, filed Sep. 21, 2025, the entirety of which is incorporated by reference herein.

This application is a continuation-in-part of Ser. No. 19/089,040, filed Mar. 25, 2025, which claims the priority of U.S. provisional patent application Ser. No. 63/657,872, filed Jun. 9, 2024, the entireties of which are incorporated by reference herein.

### BACKGROUND OF INVENTION

### 1. Field of Invention

The present invention relates to a technical field of optical alignment, and particularly to an optical alignment apparatus used between a fiber array unit and a photonic integrated circuit.

### 2. Related Art

Photonic integrated circuits (PICs) are widely used in applications, such as optical routers and switches, and bring great benefits to the development of industries requiring high-performance data exchange, long-distance interconnection, 5G facilities, and computing equipment. During the coupling and bonding process between PICs and fiber arrays, a gap between waveguides of PICs and end faces of fiber arrays plays a critical role. The gaps define the thickness of optical adhesive layers applied between the PICs and the fiber arrays. To ensure sufficient coupling efficiency while preventing damage to waveguides of the PICs during the coupling and bonding process, it is imperative to precisely control alignment and the separation distance between the waveguides of PICs and the end faces of fiber arrays.

### SUMMARY OF INVENTION

An object of the present application is to provide an optical alignment apparatus for optically aligning a fiber array unit with a photonic integrated circuit.

To achieve the above-mentioned object, the present application provides an optical alignment apparatus for aligning a fiber array unit with a photonic integrated circuit, the fiber array unit including a ferrule element and a plurality of optical fibers, and the photonic integrated circuit including a plurality of waveguide paths. The optical alignment apparatus includes an optical processing device, at least an alignment optical fiber unit, a computer control system, a multiaxial adjustment device, and a first reflection portion and a second reflection portion. The optical processing device includes at least a light output module and an optical detection module configured to generate a detection result. The alignment optical fiber unit includes a first alignment optical fiber and a second alignment optical fiber. The first alignment optical fiber includes an end located at the optical processing device and a first coupling end located at the ferrule element of the fiber array unit. The second alignment optical fiber includes an end located at the optical processing device and a second coupling end located at the ferrule element, and the optical fibers are arranged between the first and second alignment optical fibers. The computer control system is connected to the optical processing device and is configured to generate an adjustment signal based on the detection result. The multiaxial adjustment device is connected to the computer control system and configured to hold the ferrule element. The first reflection portion and the second reflection portion are disposed on opposite sides of the waveguide paths. The first coupling end of the first alignment optical fiber is positioned at a first distance from the first reflection portion in a first direction, the second coupling end of the second alignment optical fiber is positioned at a second distance from the second reflection portion in the first direction, and the multiaxial adjustment device is configured to, based on the adjustment signal, adjust a position of the ferrule element such that the first distance and the second distance are equal.

Optionally, the ferrule element includes an end surface facing the photonic integrated circuit, the first coupling end of the first alignment optical fiber and the second coupling end of the second alignment optical fiber are located close to the end surface and positioned at the same distance from the end surface.

Optionally, the photonic integrated circuit defines a coupling surface facing the end surface, the first reflection portion and the second reflection portion are coplanar with the coupling surface.

Optionally, the multiaxial adjustment device is configured, under control o the computer control system, to adjust a position of the ferrule element in a second direction or a third direction while maintaining the first distance and the second distance at equal lengths, so that the optical fibers are optically aligned with the waveguide paths of the photonic integrated circuit. The first direction, the second direction, and the third direction are perpendicular to one another.

Optionally, the multiaxial adjustment device, in response to an insertion loss occurring between the optical fibers and the waveguide paths during optical coupling, is configured to adjust the position of the ferrule element in the second direction or the third direction.

Optionally, the multiaxial adjustment device includes a first holding member configured to hold and adjust the position of the ferrule element, and a second holding member is configured to hold the photonic integrated circuit.

Optionally, each of the first alignment optical fiber and the second alignment optical fiber has a mode field diameter greater than or equal to a mode field diameter of each of the optical fibers.

Optionally, each of the first reflection portion and the second reflection portion has a dimension larger than a mode field diameter of each of the first alignment optical fiber and the second alignment optical fiber.

Optionally, a plurality of the alignment optical fiber units are connected with the ferrule element and arranged corresponding to a plurality of the first reflection portions and second reflection portions.

Optionally, centers of the first alignment optical fiber, the second alignment optical fiber, and the optical fibers are collinearly aligned.

Optionally, the optical processing device includes a first processing unit a a second processing unit, the first alignment optical fiber is connected between the first processing unit and the ferrule element, and the second alignment optical fiber is connected between the second processing unit and the ferrule element.

Optionally, each of the first and second processing units includes the light output module and the optical detection module, the light output modules are configured to provide output light signals to travel through the first alignment optical fiber and the second alignment optical fiber, respectively, and the optical detection modules are configured to detect reflective light signals reflected from the output light signals by the first and the second reflection portions.

Optionally, the multiaxial adjustment device is configured to hold a plurality of the ferrule elements connected with the fiber array units, and the photonic integrated circuit includes a plurality of transmission units each including the waveguide paths, the first reflection portion, and the second reflection portion. The plurality of ferrule elements are arranged in a one-to-one correspondence with the transmission units.

Optionally, the end surfaces of the ferrule elements are aligned with each other, and the multiaxial adjustment device is configured to simultaneously adjust positions of the ferrule elements with respect to the transmission units, so that the first alignment optical fiber and the second alignment optical fiber of each of the ferrule elements are concurrently disposed in position, with the first distance and the second distance being equal.

The present application utilizes the output light signals emitted by the optical processing device to strike the photonic integrated circuit, and through the reflection of the output light signals, the optical processing device (the OCT spectrometer) and the computer control system analyze, calculate, and determine whether the first and second distances between the outermost ends of the optical fibers and the coupling surface of the photonic integrated circuit are the same. This first achieves alignment of the outermost ends of the optical fibers with the photonic integrated circuit in the X, Yplane, and then fine-tunes the distance in the X-axis direction, thereby significantly reducing alignment time, improving optical alignment efficiency, and lowering the cost of optical alignment.

### BRIEF DESCRIPTION OF DRAWINGS

To describe the technical solutions in the embodiments of the present application, the following briefly introduces the drawings for describing the embodiments. The drawings in the following description show merely some embodiments of the present application, and a person skilled in the art may still derive other drawings from these drawings without creative efforts.

FIG. 1 is a schematic structural view of an optical alignment apparatus f optically aligning a fiber array unit with a photonic integrated circuit in an embodiment of the present application.

FIG. 2 is a schematic view showing an optical alignment process between the fiber array unit and the photonic integrated circuit under control of the optical alignment apparatus shown in FIG. 1.

FIGS. 3A and 3B are schematic views showing various situations of the optical alignment process between the fiber array unit and the photonic integrated circuit under control of the optical alignment apparatus.

FIG. 4 is a schematic structural view of an optical alignment apparatus f optically aligning a plurality of fiber array units with a photonic integrated circuit in an embodiment of the present application.

FIG. 5 is a schematic structural view of a principle of an optical alignment apparatus for optically aligning a fiber array unit with a photonic integrated circuit in an embodiment of the present application.

FIG. 6 is a schematic view showing a situation of the alignment process between the fiber array unit and the photonic integrated circuit under control of the optical alignment apparatus.

### DESCRIPTION OF PREFERRED EMBODIMENTS

The following embodiments are referring to the drawings for exemplifying specific implementable embodiments of the present application. Directional terms described by the present application, such as upper, lower, front, back, left, right, inner, outer, side, etc., are only directions by referring to the drawings, and thus the directional terms are used to describe and understand the present application, but the present application is not limited thereto.

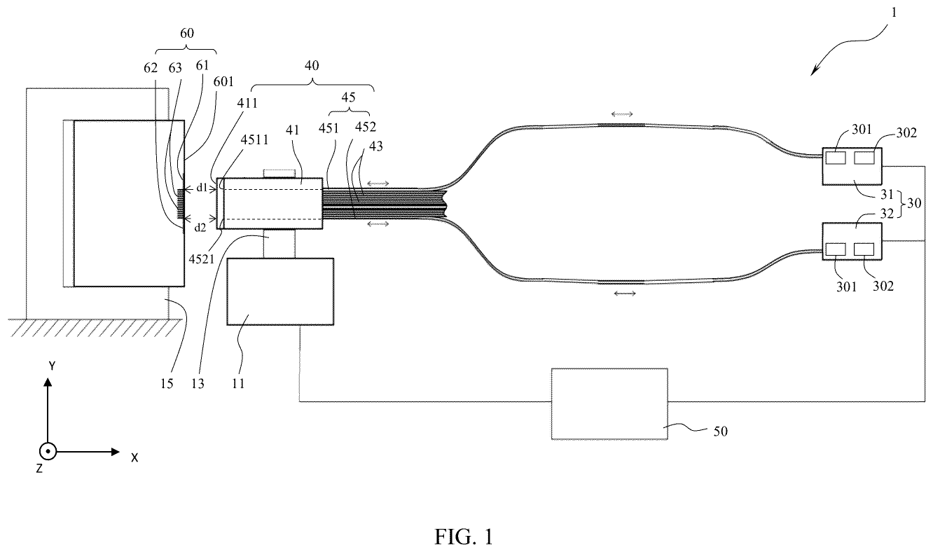

Referring to FIG. 1, which is a schematic structural view of an optical alignment apparatus 1 for optically aligning a fiber array unit 40 with a photonic integrated circuit 60 in an embodiment of the present application, the optical alignment apparatus 1 includes a multiaxial adjustment device 11, a first holding member 13, a second holding member 15, an optical processing device 30, an alignment optical fiber unit 45, and a computer control system 50. In some embodiments, the multiaxial adjustment device 11 includes a six-axial electric slide table module or a robotic arm, which enables the first holding member 13 to operate with six degrees of freedom of movement. The first holding member 13 is configured to hold the fiber array unit 40 and is movable under control of the multiaxial adjustment device 11. The second holding member 15 is configured to hold the photonic integrated circuit 60. In some embodiments, the first holding member 13 is configured to hold the fiber array unit 40 in several ways, such as, clamping, suction, magnetic attachment, or the like. In another embodiment, the first holding member 13 and the second holding member 15 can be exchanged that the first holding member 13 is fixed and the second holding member 15 is movable under control of the multiaxial adjustment device 11. In yet another embodiment, two multiaxial adjustment devices 11 may be provided to move the first holding member 13 and the second holding member 15, respectively.

As shown in FIG. 1, the fiber array unit 40 includes a ferrule element 41 and a plurality of optical fibers 43 terminated at the ferrule element 41. It should be noted that the optical fibers 43 are partially omitted in FIG. 1 for clarity. The ferrule element 41 is configured to house and position ends of the optical fibers 43 and the alignment optical fiber unit 45. In some embodiments, the ferrule element 41 includes V-shaped grooves (not shown) for holding the optical fibers 43 and defines an end surface 411 facing the photonic integrated circuit 60. In some embodiments, the alignment optical fiber unit 45 includes a first alignment optical fiber 451 and a second alignment optical fiber 452 that are arranged at opposite outer sides of the optical fibers 43 to define lateral boundaries of the optical fibers 43. In some embodiments, each of the first alignment optical fiber 451 and the second alignment optical fiber 452 has a mode field diameter (MFD) greater than or equal to a mode field diameter of each of the optical fibers 43. Preferably, the MFD of each of the first and second alignment optical fibers 451 and 452 is greater than the MFD of the optical fiber 43, enabling a relatively larger light irradiation range, thereby facilitating alignment process of the first and second alignment optical fibers 451 and 452 in a first direction, that is, X-axis direction.

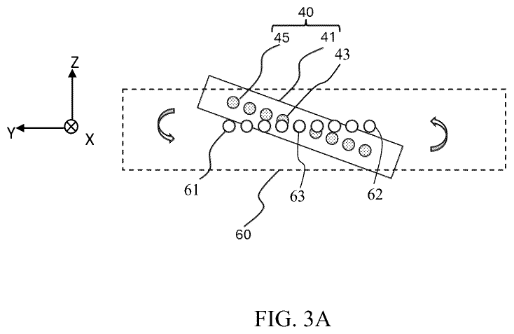

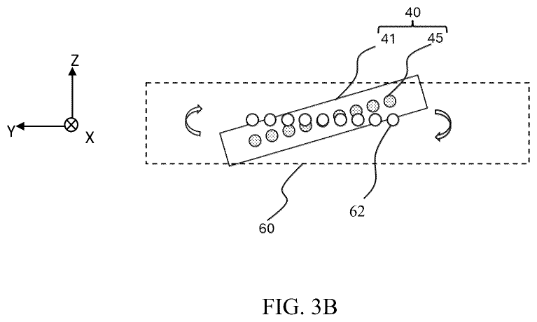

Specifically, as shown in FIG. 1, the first alignment optical fiber 451 includes an end located at the optical processing device 30 and a first coupling end 4511 located close to the end surface 411, the second alignment optical fiber 452 includes an end located at the optical processing device 30 and a second coupling end 4521 located close to the end surface 411, and the optical fibers 43 are arranged between the first alignment optical fiber 451 and the second alignment optical fiber 452, with ends of the optical fibers 43 being located close to the end surface 411. In some embodiments, centers of the first alignment optical fiber 451, the second alignment optical fiber 452, and the optical fibers 43 are collinearly aligned (as shown in FIG. 3A, described below), thereby enabling one-time alignment of the optical fibers 43.

The photonic integrated circuit 60 is configured for electro-optical conversion and photoelectric conversion. As shown in FIG. 1, the photonic integrated circuit 60 defines a coupling surface 601 facing the ferrule element 41 and includes a first reflection portion 61, a second reflection portion 62, and a plurality of waveguide paths 63. Specifically, the waveguide paths 63 are arranged at pitches corresponding to the optical fibers 43. The first reflection portion 61 and the second reflection portion 62 are positioned on the coupling surface 601, and the waveguide paths 63 are arranged between the first reflection portion 61 and the second reflection portion 62. Preferably, the first reflection portion 61 and the second reflection portion 62 are formed as planar surfaces and coplanar with the coupling surface 601. It should be noted that portions of the waveguide paths 63 are omitted for clarity.

In some embodiments, the first reflection portion 61 and the second reflection portion 62 may be formed of a material or configured with a shape configured to facilitate light reflection from the first alignment optical fiber 451 and the second alignment optical fiber 452. In some other embodiments, each of the first reflection portion 61 and the second reflection portion 62 has a dimension larger than the mode field diameter of each of the first alignment optical fiber 451 and the second alignment optical fiber 452.

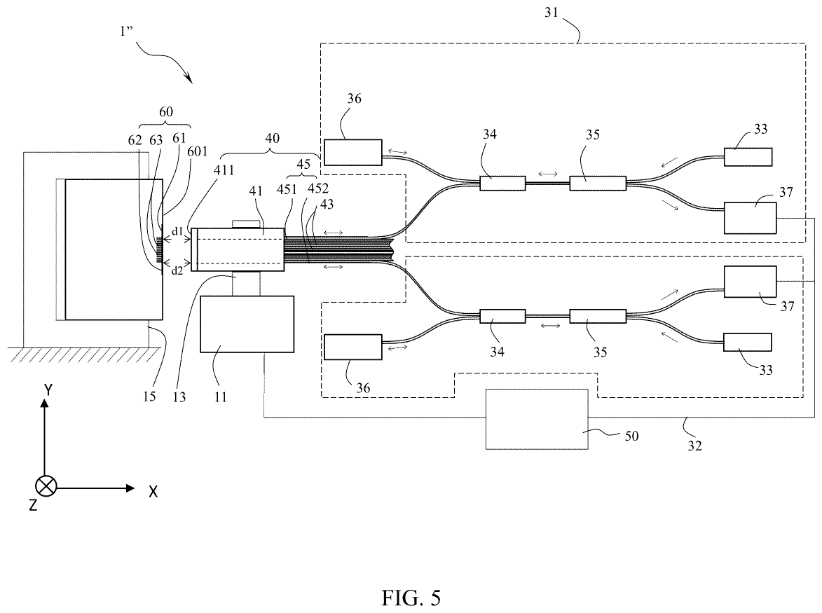

Still referring to FIG. 1, in this embodiment, the optical processing device 30 includes a first processing unit 31 and a second processing unit 32. The optical processing device 30 is implemented as an optical coherence tomography (OCT) spectrometer, preferably, a common-path OCT. In detail, OCT is a non-invasive imaging technique that employs interferometric principles to obtain high resolution, cross-sectional tomographic images that characterize the depth structure of a sample. OCT has been described as a type of “optical ultrasound,” imaging reflected energy from a target object to obtain cross-sectional data. In some embodiments, as shown in FIG. 1, each of the first and second processing units 31 and 32 includes a light output module 301 and an optical detection module 302. Specifically, the light output modules 301 are configured to provide output light signals to travel through the first alignment optical fiber 451 and the second alignment optical fiber 452, respectively. The optical detection modules 302 are configured to detect reflective light signals reflected by the first reflection portion 61 and the second reflection portion 62 from the output light signals. The reflective light signal from the first reflection portion 61 or the second reflection portion 62 may be referred to as a sample arm, and the reflective light signal from the reference reflector 36 (as show in FIG. 5) may be referred to as a reference arm.

As shown in FIG. 1, the end of the first alignment optical fiber 451 is located at the first processing unit 31, and the end of the second alignment optical fiber 452 is located at the second processing unit 32. The first processing unit 31 and the second processing unit 32 are electrically connected to the computer control system 50. Specifically, the optical detection module 302 is configured to generate a detection result. In detail, an interference fringe signal is generated by the recombination of light signals of the sample arm and the reference arm, with the light intensity varying as a function of their optical path difference, and the detection result contains the optical path difference. The computer control system 50 is connected to the multiaxial adjustment device 11 via wired or wireless communication and is configured to generate an adjustment signal based on the detection result.

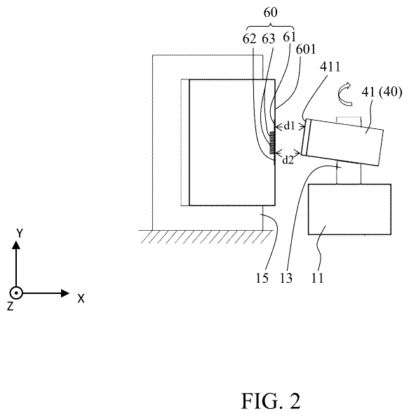

Referring to FIG. 2, showing an optical alignment process between the fiber array unit 40 and the photonic integrated circuit 60 rotated about a Z-axis direction under control of the optical alignment apparatus 1, it should be noted that certain components have been omitted from FIG. 2 for clarity. The multiaxial adjustment device 11 is configured, under control of the computer control system 50, to adjust a position of the ferrule element 41 in a second direction or a third direction. In some embodiments, the second direction is a Y-axis direction, and the third direction is the Z-axis direction.

As shown in FIG. 2, in the optical alignment process, the ferrule element 41 of the fiber array unit 40 is moved, under the control of the multiaxial adjustment device 11, toward the waveguide paths 63 of the photonic integrated circuit 60, to a predetermined distance from the coupling surface 601. The first processing unit 31 and the second processing unit 32 are configured to emit output light signals, respectively, which travel through the first alignment optical fiber 451 and the second alignment optical fiber 452 to strike the first reflection portion 61 and the second reflection portion 62 on the coupling surface 601 of the photonic integrated circuit 60. The two output light signals are reflected back toward the end surface 411 of the ferrule element 41 and enter the first coupling end 4511 and the second coupling end 4521, and subsequently return through the first alignment optical fiber 451 and the second alignment optical fiber 452. The reflected output light signals are referred to as the reference sample arms.

Then, the optical detection module 302 of each of the first processing unit 31 and the second processing unit 32 is configured to detect the first and second light signals, generate an electrical output signal based on the detection result, and transmit the electrical output signal to the computer control system 50. The computer control system 50 is configured to generate an adjustment signal based on the detection result and transmit the adjustment signal to the multiaxial adjustment device 11. In some embodiments, the adjustment signal contains data about a first distance d1 between the first reflection portion 61 and the first coupling end 4511 of the first alignment optical fiber 451, and a second distance d2 between the second reflection portion 62 and the second coupling end 4521 of the second alignment optical fiber 452.

During the optical alignment process, the first distance d1 may be greater than or less than the second distance d2, and vice versa. Based on the adjustment signal, the multiaxial adjustment device 11 is configured to actuate the first holding member 13, thereby adjusting the position of the ferrule element 41 to rotate about the Z-axis direction until the first distance d1 equals the second distance d2 in an X, Y plane, such that the end surface 411 is parallel to the coupling surface 601 in the X, Y plane. Subsequently, the position of the end surface 411 of the ferrule element 41 in the Y-axis direction is subsequently adjusted. Adjusting the ferrule element 41 orientation relative to the first reflection portion 61 or the second reflection portion 62 helps position the ferrule element 41 and the photonic integrated circuit 60 and adjust the distance between the ferrule element 41 and the photonic integrated circuit 60 without causing the ferrule element 41 to collide with the photonic integrated circuit 60. Alternatively, optical alignment can be performed using the signal strength of the optical channels to align the alignment optical fiber unit 45 with the waveguide paths 63, as described below.

In some embodiments, if the end surface 411 of the ferrule element 41 i tilted with the coupling surface 601 about the Y-axis direction, the multiaxial adjustment device 11 can adjust the fiber array unit 40 slightly around the Y-axis to determine an orientation of the fiber array unit 40 with a maximum returning signal magnitude. The output light signal output from the first or second alignment optical fibers 451 or 452 and reflected by the first reflection portion 61 or the second reflection portion 62 will reach its maximum value when optical beams from the alignment optical fiber unit 45 is incident to the first reflection portion 61 or the second reflection portion 62 orthogonally. In other words, the ferrule element 41 is parallel with the coupling surface 601 without tilting. That is, the multiaxial adjustment device 11 is configured, under control of the computer control system 50, to adjust the position of the ferrule element 41 in the second direction or the third direction while maintaining the first distance D1 and the second distance D2 at equal lengths, so that the optical fibers 43 are optically aligned with the waveguide paths 63 of the photonic integrated circuit 60.

Referring to FIGS. 3A and 3B, are schematic views showing various situations of the optical alignment process between the fiber array unit 40 and the photonic integrated circuit 60 rotated about the X-axis direction under control of the optical alignment apparatus 1. As described above, after the optical fibers 43 are positioned in advance to be optically aligned with the coupling surface 601 rotated about the Z-axis direction, the position of the end surface 411 of the ferrule element 41 rotated about the X-axis direction can be adjusted. In some embodiments, the optical alignment between the optical fibers 43 and the waveguide paths 63 can be achieved by detecting an insertion loss of the signal power in the alignment optical fiber unit 45 and adjusting the insertion loss to a predetermined value by moving the ferrule element 41. In this embodiment, the light signals are transmitted from the optical processing device 30 to the alignment optical fiber unit 45, thereby eliminating the need to power on a light source on the photonic integrated circuit 60 and simplifying the entire optical alignment process.

Referring to FIGS. 3A and 3B, illustrating side plan views, the ferrule element 41 of the fiber array unit 40 is adjusted in position to optically align the optical fibers 43 with the photonic integrated circuit 60, based on an active optical alignment process for the optical fibers 43. Specifically, the ferrule element 41 tilts in a counterclockwise direction with respect to the photonic integrated circuit 60 as shown in FIG. 3A, and tilts in a clockwise direction with respect to the photonic integrated circuit 60 as shown in FIG. 3B to align the optical fibers 43 with the waveguide paths 63. As a result, all the optical fibers 43 are optically aligned with the waveguide paths 63 in a one-time alignment process. In detail, the multiaxial adjustment device 11, in response to an insertion loss occurring between the optical fibers 43 and the waveguide paths 63 during optical coupling, is configured to adjust the position of the ferrule element 41 in the second direction or the third direction while maintaining the first distance D1 and the second distance D2 at equal lengths, thereby optically aligning the optical fibers 43 with the waveguide paths 63.

Because a bonding gap between the coupling surface 601 of the photonic integrated circuit 60 and the end surface 411 of the ferrule element 41 is precisely maintained with the aid of the alignment optical fiber unit 45 and the optical processing device 30, and the alignment between the optical fibers 43 and waveguide paths 63 is precisely maintained with the aid of active optical alignment process, thereby allowing an optical adhesive layer (not shown) applied in the bonding gap to bond the fiber array unit 40 to the photonic integrated circuit 60 while ensuring sufficient coupling efficiency.

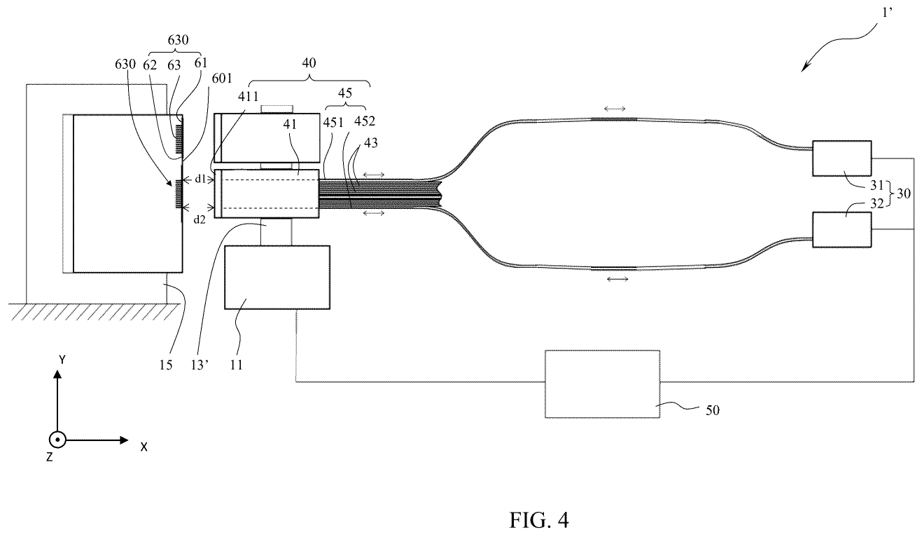

Referring to FIG. 4, which is a schematic structural view of an optical alignment apparatus 1′ for optically aligning a plurality of the fiber array units 40 with the photonic integrated circuit 60. In some embodiments, a first holding member 13′ is configured to hold a plurality of ferrule elements 41 of the fiber array units 40, and the photonic integrated circuit 60 is configured with a plurality of transmission units 630 of the waveguide paths 63 spaced apart from each other and arranged to adjoin the coupling surface 601. Each transmission unit 630 includes the first reflection portion 61, the second reflection portion 62, and the waveguide paths 63. The plurality of ferrule elements 41 are arranged in a one-to-one correspondence with the transmission units 630.

Similarly to the aforementioned embodiment shown in FIG. 1, as shown in FIG. 4, the first holding member 13′ is controlled by the multiaxial adjustment device 11 to concurrently adjust the positions of the ferrule elements 41 until the end surface 411 of each of the ferrule elements 41 is parallel to the coupling surface 601 in the X, Y plane. The distance between the coupling surface 601 and the end surface 411 of each of the ferrule element 41 in the X-axis direction is also controlled by the multiaxial adjustment device 11, the optical processing device 30, and the computer control system 50.

Further, the end surfaces 411 of the ferrule elements 41 are aligned with each other, and the multiaxial adjustment device 11 is configured to simultaneously adjust the position of the ferrule elements 41 with respect to the transmission units 630, so that the first alignment optical fiber 451 and the second alignment optical fiber 452 of each of the ferrule elements 41 are concurrently disposed in position, with the first distance D1 and the second distance D2 being equal. That is, the plurality of fiber array units 40 are positioned in optical alignment with the waveguide paths 63 of the transmission units 630 in a one-time active optical alignment process, thereby greatly reducing the time of alignment and improving the efficiency of optical alignment.

Referring to FIG. 5, FIG. 5 is a schematic structural view of a principle an optical alignment apparatus 1″ in accordance with another embodiment of the present application. In this embodiment, the first processing unit 31 and the second processing unit 32 of the optical processing device 30 of the optical alignment apparatus 1″ further includes an external light source 33, a coupler 34, a circulator 35, a reference reflector 36, and a photo-detector 37 to work as an OCT spectrometer. The coupler 34 is configured to split the light from the external light source 33 into two path, one path enters the reference arm and the other path enters the sample arm and to couple the light reflected from the both arm, and the circulator 35 is configured to allow optical signals to circulate unidirectionally between multiple ports such as directing the light from the external light source 33 to the coupler 34 and directing the light from the coupler 34 to the photo-detector 37. The photo-detector 37 detects the signal interference between the signals reflected from the reference reflector 36 and the signal reflected from the first reflection portion 61 or the second reflection portion 62 and enhancing the precision of optical alignment between the fiber array unit 40 and the photonic integrated circuit 60.

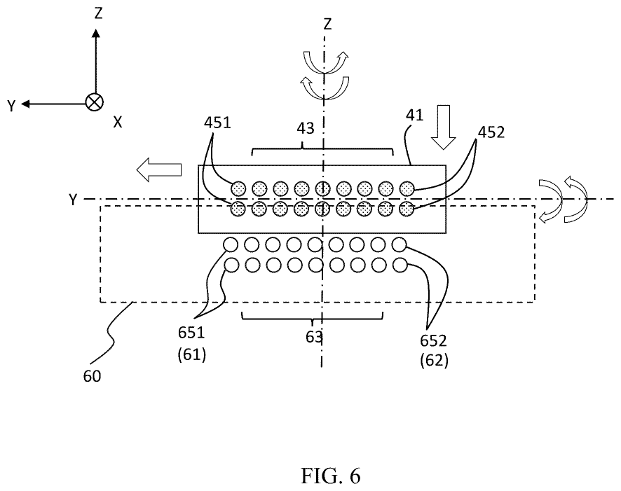

Referring to FIG. 6, in any of the aforementioned embodiments or another embodiment, a plurality of the alignment optical fiber units 45 are connected with the ferrule element 41 and arranged corresponding to a plurality of the first reflection portions 61 and second reflection portions 62. Specifically, each of the alignment optical fiber unit 45 includes the first alignment optical fibers 451 and the second alignment optical fibers 452 that are arranged at opposite outer sides of the optical fibers 43 to define lateral and longitude boundaries of the optical fibers 43.

As described above, the fiber array unit 40 is movable under control of the multiaxial adjustment device 11 and rotated about the Z-axis based on the reflective light signals returned from the first alignment optical fiber 451 and the second alignment optical fiber 452. In addition, the fiber array unit 40 is movable under control of the multiaxial adjustment device 11 and rotated about the Y-axis based on detecting changing of signal magnitude of the reflective light signals returned from the plurality of the first alignment optical fibers 451 or from the second alignment optical fibers 452 to make sure that the end surface 411 of the fiber array unit 40 is positioned in parallel with the coupling surface 601 of the photonic integrated circuit 60 and prevent from collision between the fiber array unit 40 and the photonic integrated circuit 60 when adjusting the position of the fiber array unit 40 toward the photonic integrated circuit 60 along the X-axis.

In an embodiment, a rough alignment can be achieved by aiding from a camera (not shown) that is connected to the computer control system 50 to control the fiber array unit 40 to move alone the Z-axis or Y-axis while traveling toward the photonic integrated circuit 60 along the X-axis under control of the multiaxial adjustment device 11. A first fine alignment that ensures the end surface 411 of the fiber array unit 40 disposed in parallel with the coupling surface 601 of the photonic integrated circuit 60 can be achieved by the method mentioned in the immediately preceding paragraph. A second fine alignment can be achieved by an active optical alignment process that the photonic integrated circuit 60 is provided with first alignment channels 651 with returning paths and second alignment channels 652 with returning paths to receive and return the first optical signal and the second optical signal from the first alignment optical fibers 451 and the second alignment optical fibers 452. The optical processing device 30 detects changing of signal magnitude when the multiaxial adjustment device 11 moves the fiber array unit 40 slightly to determine an orientation with a maximum signal magnitude. In the fine alignment process, the multiaxial adjustment device 11 can control the fiber array unit 40 to rotate about the X-axis or to move alone the X, Y, or Z-axes.

Accordingly, the present application utilizes the output light signals emitted by the optical processing device to strike the photonic integrated circuit, and through the reflection of the output light signals, the optical processing device (the OCT spectrometer) and the computer control system analyze, calculate, and determine whether the first and second distances between the outermost ends of the optical fibers and the coupling surface of the photonic integrated circuit are the same. This first achieves alignment of the outermost ends of the optical fibers with the photonic integrated circuit in the X, Y plane, and then fine-tunes the distance in the X-axis direction, thereby significantly reducing alignment time, improving optical alignment efficiency, and lowering the cost of optical alignment.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the described embodiments may be made without departing from the scope of the application.

What is claimed is:

1. An optical alignment apparatus for aligning a fiber array unit with a photonic integrated circuit, the fiber array unit comprising a ferrule element and a plurality of optical fibers, the photonic integrated circuit comprising a plurality of waveguide paths and a first reflection portion and a second reflection portion disposed on opposite sides of the waveguide paths, and the optical alignment apparatus comprising:
an optical processing device comprising at least a light output module and an optical detection module configured to generate a detection result;
at least an alignment optical fiber unit comprising a first alignment optical fiber and a second alignment optical fiber, wherein the first alignment optical fiber includes an end located at the optical processing device and a first coupling end located at the ferrule element of the fiber array unit, the second alignment optical fiber includes an end located at the optical processing device and a second coupling end located at the ferrule element, and the plurality of optical fibers are arranged between the first and second alignment optical fibers;
a computer control system connected to the optical processing device and configured to generate an adjustment signal based on the detection result; and
a multiaxial adjustment device connected to the computer control system and configured to hold the ferrule element;
wherein the first coupling end of the first alignment optical fiber is positioned at a first distance from the first reflection portion in a first direction, the second coupling end of the second alignment optical fiber is positioned at a second distance from the second reflection portion in the first direction, and the multiaxial adjustment device is configured to, based on the adjustment signal, adjust a position of the ferrule element such that the first distance and the second distance are equal.

2. The optical alignment apparatus of claim 1, wherein the ferrule element comprises an end surface facing the photonic integrated circuit, the first coupling end of the first alignment optical fiber and the second coupling end of the second alignment optical fiber are located close to the end surface and positioned at a same distance from the end surface.

3. The optical alignment apparatus of claim 2, wherein the photonic integrated circuit defines a coupling surface facing the end surface, the first reflection portion and the second reflection portion are coplanar with the coupling surface.

4. The optical alignment apparatus of claim 1, wherein the multiaxial adjustment device is configured, under control of the computer control system, to adjust a position of the ferrule element in a second direction or a third direction while maintaining the first distance and the second distance at equal lengths, so that the optical fibers are optically aligned with the waveguide paths of the photonic integrated circuit, wherein the first direction, the second direction, and the third direction are perpendicular to one another.

5. The optical alignment apparatus of claim 4, wherein the multiaxial adjustment device, in response to an insertion loss occurring between the optical fibers and the waveguide paths during optical coupling, is configured to adjust the position of the ferrule element in the second direction or the third direction.

6. The optical alignment apparatus of claim 1, wherein the multiaxial adjustment device comprises a first holding member configured to hold and adjust the position of the ferrule element, and a second holding member configured to hold the photonic integrated circuit.

7. The optical alignment apparatus of claim 1, wherein each of the first alignment optical fiber and the second alignment optical fiber has a mode field diameter greater than or equal to a mode field diameter of each of the optical fibers.

8. The optical alignment apparatus of claim 1, wherein each of the first reflection portion and the second reflection portion has a dimension larger than a mode field diameter of each of the first alignment optical fiber and the second alignment optical fiber.

9. The optical alignment apparatus of claim 1, wherein a plurality of the alignment optical fiber units are connected with the ferrule element and arranged corresponding to a plurality of the first reflection portions and second reflection portions.

10. The optical alignment apparatus of claim 1, wherein centers of t first alignment optical fiber, the second alignment optical fiber, and the optical fibers are collinearly aligned.

11. The optical alignment apparatus of claim 1, wherein the optical processing device comprises a first processing unit and a second processing unit, the first alignment optical fiber is connected between the first processing unit and the ferrule element, and the second alignment optical fiber is connected between the second processing unit and the ferrule element.

12. The optical alignment apparatus of claim 11, wherein each of the first and second processing units comprises the light output module and the optical detection module, the light output modules are configured to provide output light signals to travel through the first alignment optical fiber and the second alignment optical fiber, respectively, and the optical detection modules are configured to detect reflective light signals reflected from the output light signals by the first and the second reflection portions.

13. The optical alignment apparatus of claim 1, wherein the multiaxial adjustment device is configured to hold a plurality of the ferrule elements connected with the fiber array units, and the photonic integrated circuit comprises a plurality of transmission units each comprising the waveguide paths, the first reflection portion, and the second reflection portion, wherein the plurality of ferrule elements are arranged in a one-to-one correspondence with the transmission units.

14. The optical alignment apparatus of claim 13, wherein the end surfaces of the ferrule elements are aligned with each other, and the multiaxial adjustment device is configured to simultaneously adjust positions of the ferrule elements with respect to the transmission units, so that the first alignment optical fiber and the second alignment optical fiber of each of the ferrule elements are concurrently disposed in position, with the first distance and the second distance being equal.
